(19) United States
(12) Patent Application Publication
(10) Pub. No.: US 2022/0260224 A1
(43) Pub. Date: Aug. 18, 2022

(54) VEHICLE HEADLAMP

(71) Applicant: KOITO MANUFACTURING CO., LTD., Tokyo (JP)

(72) Inventor: Masahiko NISHIZAKI, Shizuoka (JP)

(21) Appl. No.: 17/619,409

(22) PCT Filed: Jun. 10, 2020
(86) PCT No.: PCT/JP2020/022865

§ 371 Date: Dec. 15, 2021

(30) Foreign Application Priority Data
Jun. 21, 2019 (JP) 2019-115320

(51) Int. Cl. F21S 41/29; F21S 41/25; F21S 41/20

(52) U.S. Cl. CPC F21S 41/29; F21S 41/148; F21S 41/285; F21S 41/25

(57) ABSTRACT

In a vehicle headlamp, a projection lens made of acrylic and a lens holder made of polycarbonate are joined with each other by a laser welding. The projection lens has a joint surface and is transparently formed. The lens holder has a welding surface that is joined to the joint surface and is transparently formed. The welding surface is irradiated with laser light having a wavelength of 1,550 nm to 1,640 nm transmitted through the projection lens to join the projection lens and the lens holder with each other.

### TECHNICAL FIELD

The present disclosure relates to a technical field of a vehicle headlamp in which a projection lens and a lens holder are joined with each other by laser welding.

### BACKGROUND

In the vehicle headlamp, there is a so-called projector type in which a lamp unit is disposed inside a lamp outer housing constituted by a lamp housing and a cover, and the lamp unit has a projection lens and a lens holder.

In such a vehicle headlamp, the projection lens and the lens holder are joined by a laser welding (see, e.g., Patent Document 1). Since the laser welding is advantageous in that, for example, a high joint strength is obtained with a small joint range, and the manufacturing cost is reduced without the need for consumables such as adhesives or screws, the laser welding is widely used as a method for joining the projection lens and the lens holder.

The projection lens is formed transparent to transmit light emitted from a light source, is often made of acrylic, which is easy to form into a thick shape to secure light distribution performance, and includes a hemispherical light controller that controls incident light and a flange portion that protrudes outward from the light controller. Meanwhile, the lens holder that holds the projection lens is often made of polycarbonate to secure a high heat resistance, and the lens holder contains a black pigment that absorbs heat when irradiated with laser light in a laser welding.

When the projection lens and the lens holder are joined with each other by the laser welding, laser light is transmitted through the flange and irradiates a welding surface of the lens holder, and the black pigment reacts with the laser light to cause the portion irradiated with the laser light to generate heat and to be melted. When the welding surface is irradiated with the laser light, the heat generated in the lens holder is transferred to the flange portion of the projection lens so that a part of the flange portion is melted, and thus, the melted portion of the lens holder and the melted portion of the projection lens are welded and joined with each other.

### PRIOR ART DOCUMENT

### Patent Document

Patent Document: Japanese Laid-Open Patent Publication 2013-89483

### SUMMARY OF THE INVENTION

### Problem to be Solved

It is possible to secure high joint strength between the projection lens and the lens holder by joining them by the laser welding. However, since the lens holder contains the black pigment, the lens holder is formed in black color, and thus, the lens holder may also react to sunlight that may be incident on the vehicle headlamp. Therefore, when sunlight is incident on the inside of the vehicle headlamp, the lens holder may unintentionally be melted depending on the amount of the incident light.

Further, in the vehicle headlamp, it is desired that the lens holder is transparently formed similar to the projection lens, in order to improve visibility.

Therefore, the vehicle headlamp according to the present disclosure is to prevent the lens holder from being melted and to improve visibility while securing high joint strength between the projection lens and the lens holder.

### Means to Solve the Problem

First, a vehicle headlamp according to the present disclosure is a vehicle headlamp in which a projection lens made of acrylic and a lens holder made of polycarbonate are joined with each other by laser welding. The projection lens has a joint surface and is transparently formed. The lens holder has a welding surface that is joined to the joint surface and is transparently formed. The welding surface is irradiated with laser light having a wavelength of 1,550 nm to 1,640 nm transmitted through the projection lens to join the projection lens and the lens holder with each other.

Therefore, the welding surface of the lens holder transparently formed is irradiated with the laser light having a wavelength of 1,550 nm to 1,640 nm transmitted through the projection lens transparently formed to join the projection lens and the lens holder with each other.

Second, in the vehicle headlamp according to the present disclosure, a condensing lens may be disposed on an optical path of the laser light.

Therefore, the laser light is transmitted through the projection lens in a condensed state by the condensing lens, and thus, the energy density of the light is lowered on an incident surface of the projection lens so that heat generation is less likely to occur, and the energy density of the light is increased on the welding surface of the lens holder so that heat is easily generated.

Third, in the vehicle headlamp according to the present disclosure, a filter made of acrylic may be disposed on the optical path of the laser light.

Therefore, a wavelength component of the laser light absorbed by the projection lens is absorbed by the filter before being transmitted through the projection lens.

Fourth, a vehicle headlamp according to another aspect of the present disclosure is a vehicle headlamp in which a projection lens made of acrylic and a lens holder made of polycarbonate are joined with each other by a laser welding. The projection lens has a welding surface and is transparently formed. The lens holder has a joint surface that is joined to the welding surface and is transparently formed. The welding surface is irradiated with laser light having a wavelength of 1,850 nm to 1,960 nm transmitted through the lens holder to join the projection lens and the lens holder with each other.

Therefore, the welding surface of the projection lens transparently formed is irradiated with the laser light having a wavelength of 1,850 nm to 1,960 nm transmitted through the lens holder transparently formed to join the projection lens and the lens holder with each other.

Fifth, in the vehicle headlamp according to another aspect of the present disclosure, a condensing lens may be disposed on an optical path of the laser light.

Therefore, the laser light is transmitted through the lens holder in a condensed state by the condensing lens, and thus, the energy density of the light is lowered on an incident surface of the lens holder so that heat generation is less likely to occur, and the energy density of the light is increased on the welding surface of the projection lens so that heat is easily generated.

Sixth, in the vehicle headlamp according to another aspect of the present disclosure, a filter made of acrylic may be disposed on the optical path of the laser light.

Therefore, a wavelength component of the laser light absorbed by the lens holder is absorbed by the filter before being transmitted through the lens holder.

### Effect of the Invention

According to the present disclosure, the welding surface of the lens holder or the projection lens transparently formed is irradiated with laser light having a predetermined wavelength transmitted through the projection lens or the lens holder transparently formed to join the projection lens and the lens holder with each other, and thus, it is possible to prevent the lens holder from being melted and to improve visibility while securing high joint strength between the projection lens and the lens holder.

### BRIEF DESCRIPTION OF THE DRAWINGS

FIG. 1 illustrates an embodiment of a vehicle headlamp of the present disclosure together with FIGS. 2 to 9, and is a rear view illustrating the vehicle headlamp.

FIG. 2 is a view illustrating a projection lens and a lens holder.

FIG. 3 is a graph illustrating a spectral transmittance of acrylic.

FIG. 4 is a graph illustrating a spectral transmittance of polycarbonate.

FIG. 5 is a view illustrating an example in which a condensing lens and a filter are disposed on an optical path of laser light.

FIG. 6 illustrates another configuration of a joint portion between the projection lens and the lens holder together with FIGS. 7 to 9, and is a view illustrating the projection lens and the lens holder.

FIG. 7 is a view illustrating an example in which a condensing lens and a filter are disposed on an optical path of laser light.

FIG. 8 is a view illustrating an example having a configuration in which a holding portion covers an outer peripheral surface of the filter from an outer peripheral side.

FIG. 9 is a view illustrating an example having a configuration in which the holding portion covers a front surface of the filter from a front side.

### DETAILED DESCRIPTION TO EXECUTE THE INVENTION

Hereinafter, an embodiment for implementing a vehicle headlamp of the present disclosure will be described with reference to the accompanying drawings.

(Configuration of Vehicle Headlamp)

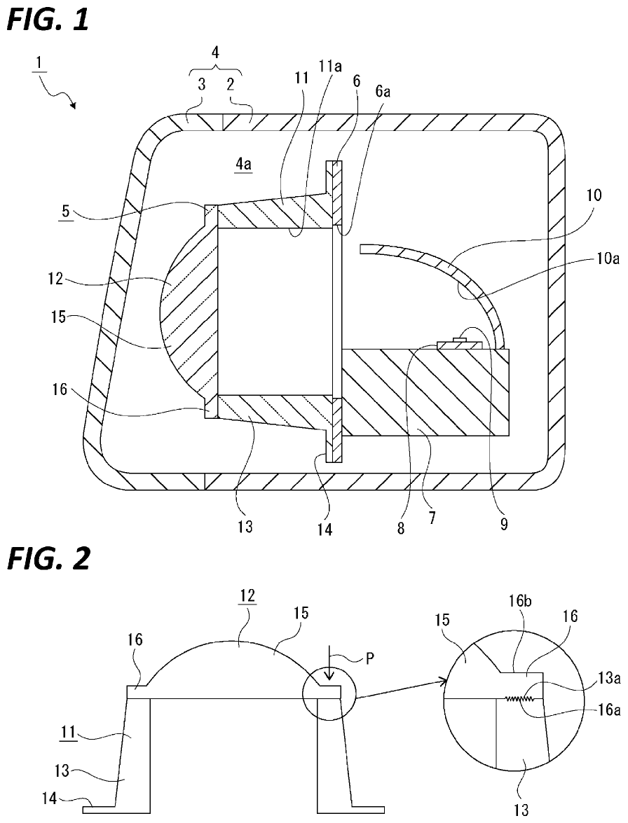

First, a configuration of a vehicle headlamp 1 will be described (see FIG. 1).

The vehicle headlamp 1 is disposed on each of left and right ends of the front end portion of a vehicle.

The vehicle headlamp 1 includes a lamp housing 2 having an opening at the front end portion and a cover 3 that closes the opening of the lamp housing 2. A lamp outer housing 4 is constituted by the lamp housing 2 and the cover 3, and an internal space of the lamp outer housing 4 is formed as a lamp chamber 4a.

A lamp unit 5 is disposed in the lamp chamber 4a. The lamp unit 5 includes a bracket 6, an arrangement base 7, a substrate 8, a light source 9, a reflector 10, a lens holder 11, and a projection lens 12.

The bracket 6 is formed in a plate-shaped annular shape facing in the front-rear direction, and has a through hole 6a.

The arrangement base 7 is made of a metal material having high heat dissipation, and is attached to a lower end side portion of a rear surface of the bracket 6. The arrangement base 7 functions as a heat sink and also functions as a light source arrangement portion for disposing a light source.

The substrate 8 is disposed on an upper surface of the arrangement base 7, and has a predetermined circuit pattern (not illustrated). The substrate 8 is connected to a power supply circuit (not illustrated).

The light source 9 is mounted on an upper surface of the substrate 8, and has an emitting surface that emits light upward. For example, a light emitting diode (LED) is used as the light source 9. The light source 9 is supplied with a driving current from the power supply circuit through the substrate 8.

A lower end portion of the reflector 10 is attached to the upper surface of a rear end portion of the arrangement base 7, and an inner surface thereof is formed as a reflecting surface 10a. The reflector 10 has a function of reflecting the light emitted from the light source 9 toward the front by the reflecting surface 10a.

The lens holder 11 is transparently made of polycarbonate, and has a rear end portion attached to a front surface of the bracket 6. The lens holder 11 includes a substantially cylindrical holding portion 13 having an axial direction in the front-rear direction and a flange-shaped attached portion 14 that protrudes outward from a rear end portion of the holding portion 13, and the attached portion 14 is attached to the bracket 6. An internal space of the lens holder 11 is formed as a light passing space 11a.

A front surface of the holding portion 13 is formed as a welding surface 13a.

The projection lens 12 is transparently made of acrylic, and is constituted by a light controller 15 formed in a substantially hemispherical shape that is convex forward, and a flange portion 16 that protrudes outward from a rear end portion of the light controller 15. The flange portion 16 has a rear surface formed as a joint surface 16a, and a front surface formed as an incident surface 16b. The projection lens 12 and the lens holder 11 are joined with each other by laser welding.

In the vehicle headlamp 1 configured as described above, when light is emitted from the light source 9, the emitted light is reflected by the reflecting surface 10a of the reflector 10, passes through the through hole 6a of the bracket 6 and the light passing space 11a of the lens holder 11, is incident on the light controller 15 of the projection lens 12, is converted into parallel light by the light controller 15, is transmitted through the cover 3, and is irradiated toward the front.

(Joining of Projection Lens and Lens Holder) Subsequently, the joining of the projection lens 12 and the lens holder 11 will be described (see FIGS. 2 to 4).

The joining of the projection lens 12 and the lens holder 11 is performed by welding the joint surface 16a and the welding surface 13a by laser welding (see FIG. 2). In the laser welding, laser light having a predetermined wavelength is emitted toward the incident surface 16b formed on the flange portion 16 of the projection lens 12, and the laser light is incident from the incident surface 16b, transmitted through the flange portion 16, and irradiated to the welding surface 13a of the holder 11. At this time, the laser light is, for example, irradiated to the welding surface 13a from a P direction orthogonal to the welding surface 13a. When the welding surface 13a is irradiated with the laser light, the portion including the welding surface 13a of the holding portion 13 generates heat and is melted, the generated heat is transferred to a portion including the joint surface 16a of the flange portion 16 to melt the portion, and both melted portions are welded.

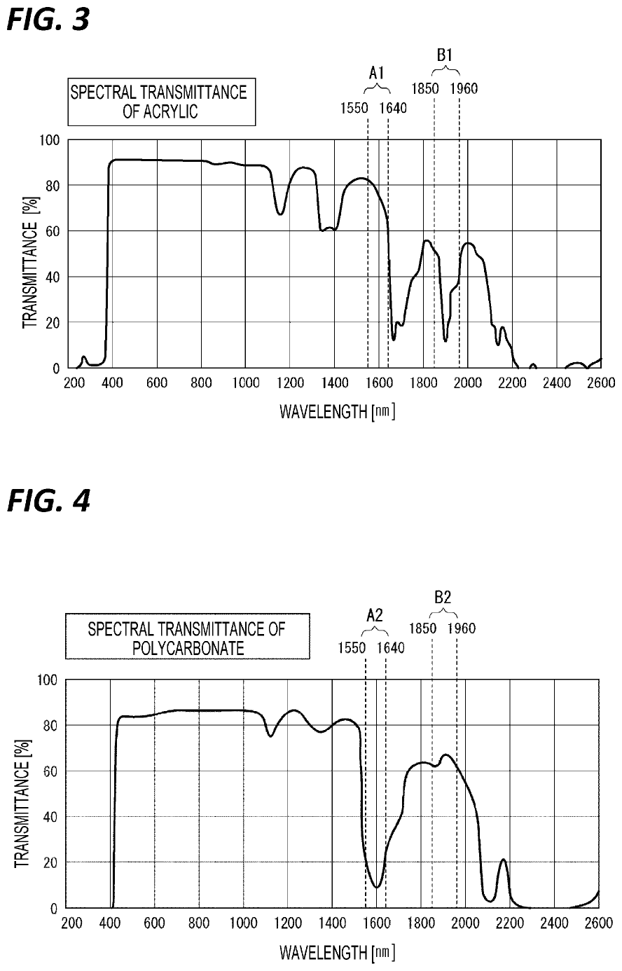

The wavelength of the laser light is in a range of 1,550 nm to 1,640 nm. The laser light having a wavelength in this range will be described with reference to graphs in FIGS. 3 and 4. In the following, the wavelength in the range of 1,550 nm to 1,640 nm will be described as a wavelength A.

FIG. 3 is a graph illustrating a spectral transmittance of acrylic which is a material of the projection lens 12, and illustrates data for acrylic having a thickness of 3 mm as an example. In FIG. 3, the horizontal axis represents a wavelength, and the vertical axis represents a transmittance. As illustrated by A1 in FIG. 3, the laser light having the wavelength A has a high transmittance of 60% or more with respect to acrylic.

FIG. 4 is a graph illustrating a spectral transmittance of polycarbonate which is a material of the lens holder 11, and illustrates data for polycarbonate having a thickness of 3 mm as an example. In FIG. 4, the horizontal axis represents a wavelength, and the vertical axis represents a transmittance. As illustrated by A2 in FIG. 4, the laser light having the wavelength A has a minimum transmittance of approximately 10% or less in the vicinity of 1,600 nm, and has a low transmittance with respect to polycarbonate.

As described above, the laser light having the wavelength A has a high transmittance with respect to acrylic and a low transmittance with respect to polycarbonate. Therefore, when the laser light having the wavelength A is emitted toward the incident surface 16b of the projection lens 12, a high transmittance of the laser light to the projection lens 12 is secured and a high absorption rate of the laser light to the lens holder 11 is secured, and thus, the welding surface 13a is irradiated with a sufficient amount of the laser light to generate a sufficient amount of heat on the welding surface 13a, and a good molten state on the welding surface 13a and the joint surface 16a is secured.

When the laser welding is performed using the laser light having the wavelength A in the range of 1,550 nm to 1,640 nm described above, depending on a laser light irradiation device, light having a wavelength that exceeds 1,640 nm may be included in a small amount when the laser light having the wavelength A is irradiated. If the light having the wavelength that exceeds 1,640 nm is irradiated, when the laser light is incident on the flange portion 16 from the incident surface 16b, a part of the laser light is absorbed by the flange portion 16 made of acrylic, which may cause the incident surface 16b to be deformed due to heat generation.

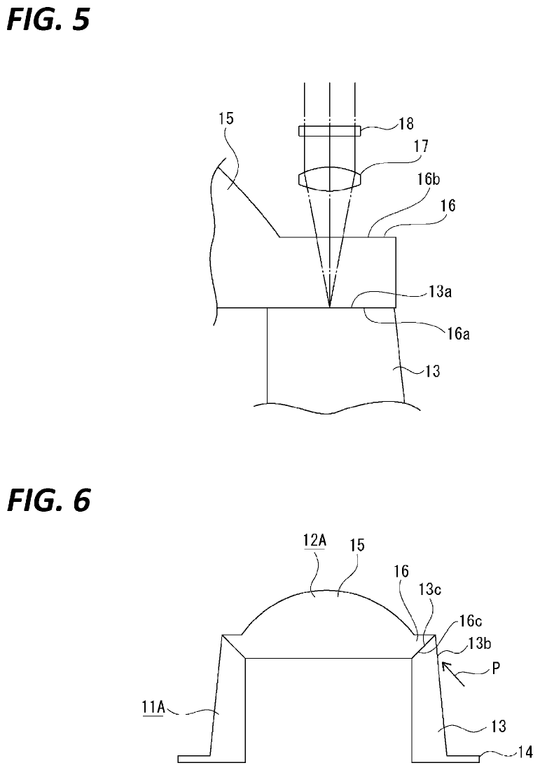

Therefore, a condensing lens 17 that condenses the laser light may be disposed on the optical path of the laser light (see FIG. 5). By disposing the condensing lens 17 on the optical path of the laser light, the laser light is condensed by the condensing lens 17 and is irradiated in a state of focusing on the welding surface 13a.

At this time, since the laser light is transmitted through the flange portion 16 of the projection lens 12 in a condensed state by the condensing lens 17, the energy density of the light is lowered on the incident surface 16b so that heat generation is less likely to occur, and the energy density of the light is increased on the welding surface 13a so that heat is easily generated. Therefore, it is possible to prevent the deformation of the incident surface 16b due to heat, and to secure high joint strength between the projection lens 12 and the lens holder 11.

Further, a filter 18 made of acrylic, which is the same material as the projection lens 12, may be disposed on the optical path of the laser light (see FIG. 5). The laser light is transmitted through the filter 18 by disposing the filter 18 on the optical path of the laser light.

At this time, a wavelength component of the laser light absorbed by the flange portion 16 is absorbed by the filter 18 before being transmitted through the flange portion 16. Therefore, the wavelength component is not incident on the flange portion 16, and thus, the deformation of the incident surface 16b due to heat may be prevented.

Further, by using the condensing lens 17 and the filter 18 in combination, it is possible to obtain a large effect of preventing the deformation of the incident surface 16b due to heat, and to secure high joint strength between the projection lens 12 and the lens holder 11.

The filter 18 is made of acrylic, which is the same material as the projection lens 12, and the filter 18 may be deformed by the heat generation due to the light having the wavelength that exceeds 1,640 nm. Therefore, when the function of the filter 18 is deteriorated by the deformation of the filter 18, it is desirable to replace the filter 18 with a new filter 18.

### SUMMARY

As disclosed above, in the vehicle headlamp 1, the welding surface 13a is irradiated with the laser light transmitted through the projection lens 12 and having the wavelength A of 1,550 nm to 1,640 nm, thereby joining the transparent projection lens 12 made of acrylic and the transparent lens holder 11 made of polycarbonate with each other.

Therefore, the welding surface 13a of the lens holder 11 transparently formed is irradiated with the laser light having the wavelength A and transmitted through the projection lens 12 transparently formed to join the projection lens 12 and the lens holder 11 with each other. Therefore, the lens holder 11 is transparent, has a good appearance, and is unlikely to be melted by sunlight, and thus, it is possible to prevent the lens holder 11 from being melted and to improve visibility while securing high joint strength between the projection lens 12 and the lens holder 11.

(Another Configuration of Projection Lens and Lens Holder)

Hereinafter, another configuration of a joint portion between the projection lens and the lens holder will be described (see FIG. 6).

A lens holder 11A according to another configuration is transparently made of polycarbonate, and a projection lens 12A according to another configuration is transparently made of acrylic. In the lens holder 11A, the upper end portion of the outer peripheral surface of the holding portion 13 is formed as an incident surface 13b. In the lens holder 11A, a joint surface 13c is formed instead of the welding surface 13a, and in the projection lens 12A, a welding surface 16c is formed instead of the joint surface 16a. The joint surface 13c and the welding surface 16c are inclined with respect to the front-rear direction, and are positioned to face each other.

The joining of the projection lens 12A and the lens holder 11A is performed by welding the welding surface 16c and the joint surface 13c by laser welding. In the laser welding, laser light having a predetermined wavelength is emitted toward the incident surface 13b formed on the holding portion 13 of the lens holder 11A, and the laser light is transmitted through the holding portion 13, and irradiated to the welding surface 16c of the projection lens 12A. At this time, the laser light is, for example, irradiated to the welding surface 16c from a P direction orthogonal to the welding surface 16c. When the welding surface 16c is irradiated with the laser light, the portion including the welding surface 16c of the flange portion 16 generates heat and is melted, the generated heat is transferred to a portion including the joint surface 13c of the holding portion 13 to melt the portion, and both melted portions are welded.

The wavelength of the laser light is in a range of 1,850 nm to 1,960 nm. The laser light having a wavelength in this range will be described with reference to graphs in FIGS. 3 and 4. In the following, the wavelength in the range of 1,850 nm to 1,960 nm will be described as a wavelength B.

As illustrated by B1 in FIG. 3, the laser light having the wavelength B has a minimum transmittance of approximately 10% in the vicinity of 1,900 nm, and has a low transmittance with respect to acrylic. As illustrated by B2 in FIG. 4, the laser light having the wavelength B has a maximum transmittance of approximately 60% or more in the vicinity of 1,900 nm, and has a high transmittance with respect to polycarbonate.

As described above, the laser light having the wavelength B has a low transmittance with respect to acrylic and a high transmittance with respect to polycarbonate. Therefore, when the laser light having the wavelength B is emitted toward the incident surface 13b of the lens holder 11A, a high transmittance of the laser light to the lens holder 11A is secured and a high absorption rate of the laser light to the projection lens 12A is secured, and thus, the welding surface 16c is irradiated with a sufficient amount of the laser light to generate a sufficient amount of heat on the welding surface 16c, and a good molten state on the joint surface 13c and the welding surface 16c is secured.

When using the laser light having the wavelength B, depending on a laser light irradiation device, light having a wavelength that exceeds 1,960 nm may be included in a small amount when the laser light having the wavelength B is irradiated. Therefore, when the laser light is incident on the holding portion 13 from the incident surface 13b, a part of the laser light is absorbed by the holding portion 13 made of polycarbonate, which may cause the incident surface 13b to be deformed due to heat generation.

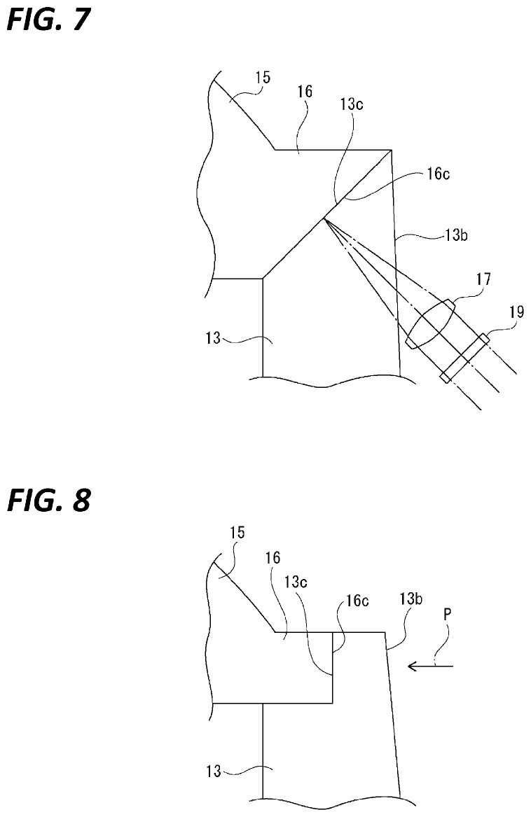

Therefore, the condensing lens 17 that condenses the laser light may be disposed on the optical path of the laser light (see FIG. 7). By disposing the condensing lens 17 on the optical path of the laser light, the laser light is condensed by the condensing lens 17 and is irradiated in a state of focusing on the welding surface 16c.

At this time, since the laser light is transmitted through the holding portion 13 of the lens holder 11A in a condensed state by the condensing lens 17, the energy density of the light is lowered on the incident surface 13b so that heat generation is less likely to occur, and the energy density of the light is increased on the welding surface 16c so that heat is easily generated. Therefore, it is possible to prevent the deformation of the incident surface 13b due to heat, and to secure high joint strength between the projection lens 12A and the lens holder 11A.

Further, a filter 19 made of polycarbonate, which is the same material as the lens holder 11A, may be disposed on the optical path of the laser light (see FIG. 7). The laser light is transmitted through the filter 19 by disposing the filter 19 on the optical path of the laser light.

At this time, a wavelength component of the laser light absorbed by the holding portion 13 is absorbed by the filter 19 before being transmitted through the holding portion 13. Therefore, the wavelength component is not incident on the holding portion 13, and thus, the deformation of the incident surface 13b due to heat may be prevented.

Further, by using the condensing lens 17 and the filter 19 in combination, it is possible to obtain a large effect of preventing the deformation of the incident surface 13b due to heat, and to secure high joint strength between the projection lens 12A and the lens holder 11A.

The filter 19 is made of polycarbonate, which is the same material as the lens holder 11A, and the filter 19 may be deformed by the heat generation due to the light having the wavelength that exceeds 1,960 nm. Therefore, when the function of the filter 19 is deteriorated by the deformation of the filter 19, it is desirable to replace the filter 19 with a new filter 19.

Further, when the projection lens 12A and the lens holder 11A are joined by laser welding using the laser light having the wavelength B, a configuration in which the laser light is transmitted through the lens holder 11A and irradiated to the projection lens 12A may be used. For example, it is possible to perform laser welding in a configuration in which the holding portion 13 covers the outer peripheral surface of the flange portion 16 from the outer peripheral side (see FIG. 8). In this case, the outer peripheral surface of the flange portion 16 of the projection lens 12A is formed as the welding surface 16c, and the surface of the lens holder 11A in contact with the welding surface 16c is formed as the joint surface 13c. At this time, the laser light is, for example, irradiated to the welding surface 16c from a P direction orthogonal to the welding surface 16c.

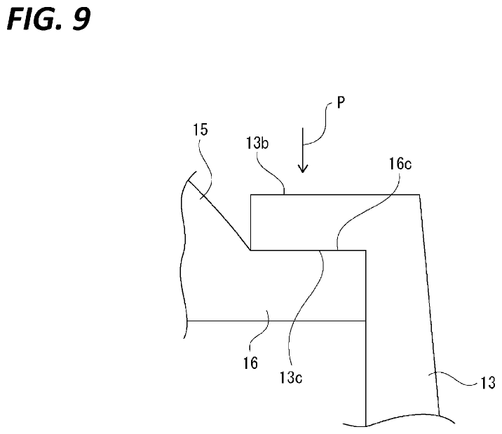

Further, when the projection lens 12A and the lens holder 11A are joined by laser welding using the laser light having the wavelength B, for example, it is also possible to perform laser welding in a configuration in which the holding portion 13 covers the front surface of the flange portion 16 from the front side (see FIG. 9). In this case, the front surface of the flange portion 16 of the projection lens 12A is formed as the welding surface 16c, and the surface of the lens holder 11A in contact with the welding surface 16c is formed as the joint surface 13c. At this time, the laser light is, for example, irradiated to the welding surface 16c from a P direction orthogonal to the welding surface 16c.

As described above, in another configuration of the vehicle headlamp 1, the welding surface 16c is irradiated with the laser light transmitted through the projection lens 12 and having the wavelength B of 1,850 nm to 1,960 nm, thereby joining the transparent projection lens 12A made of acrylic and the transparent lens holder 11A made of polycarbonate with each other.

Therefore, the welding surface 16c of the projection lens 12A transparently formed is irradiated with the laser light having the wavelength B and transmitted through the lens holder 11A transparently formed to join the projection lens 12A and the lens holder 11A with each other. Therefore, the lens holder 11A is transparent, has a good appearance, and is unlikely to be melted by sunlight, and thus, it is possible to prevent the lens holder 11A from being melted and to improve visibility while securing high joint strength between the projection lens 12A and the lens holder 11A.

### DESCRIPTION OF SYMBOLS

1: vehicle headlamp
11: lens holder
12: projection lens
13a: welding surface
16a: joint surface
16b: incident surface
17: condensing lens
18: filter
19: filter
11A: lens holder
13b: incident surface
13c: joint surface
12A: projection lens
16c: welding surface

1. A vehicle headlamp in which a projection lens made of acrylic and a lens holder made of polycarbonate are joined with each other by a laser welding,
wherein the projection lens has a joint surface and is transparently formed,
the lens holder has a welding surface that is joined to the joint surface and is transparently formed, and
the welding surface is irradiated with laser light having a wavelength of 1,550 nm to 1,640 nm transmitted through the projection lens to join the projection lens and the lens holder with each other.

2. The vehicle headlamp according to claim 1, wherein a condensing lens is disposed on an optical path of the laser light.

3. The vehicle headlamp according to claim 1, wherein a filter made of acrylic is disposed on an optical path of the laser light.

4. A vehicle headlamp in which a projection lens made of acrylic and a lens holder made of polycarbonate are joined with each other by a laser welding,
wherein the projection lens has a welding surface and is transparently formed,
the lens holder has a joint surface that is joined to the welding surface and is transparently formed, and
the welding surface is irradiated with laser light having a wavelength of 1,850 nm to 1,960 nm transmitted through the lens holder to join the projection lens and the lens holder with each other.

5. The vehicle headlamp according to claim 4, wherein a condensing lens is disposed on an optical path of the laser light.

6. The vehicle headlamp according to claim 4, wherein a filter made of polycarbonate is disposed on an optical path of the laser light.
